(19) United States
(12) Patent Application Publication
(10) Pub. No.: US 2011/0164932 A1
(43) Pub. Date: Jul. 7, 2011

(54) Cutting Insert and Milling Cutter Provided with the Same

(75) Inventors: Chang Hee Choi, Daegu (KR); Chang Gyu Park, Daegu (KR)

(73) Assignee: TaeguTec, Ltd., Dalsung-gun (KR)

(21) Appl. No.: 13/030,723

(22) Filed: Feb. 18, 2011

Related U.S. Application Data
(63) Continuation-in-part of application No. PCT/KR2009/004132, filed on Jul. 24, 2009.

(30) Foreign Application Priority Data
Aug. 20, 2008 (KR) 10-2008-0081322

(51) Int. Cl. B23C 5/22; B23C 5/06; B23B 27/16

(52) U.S. Cl. 407/40; 407/113; 407/42

(57) ABSTRACT

A milling cutter is provided with a cutting insert having improved main cutting edges. The main cutting edges are positioned along both lengthwise edges of a front surface, have a wave shape and are asymmetrical with each other. Main cutting edges positioned along both lengthwise edges of a back surface are rotationally symmetrical by 180 degrees from the main cutting edges of the front surface with respect to a longitudinal central axis of the cutting insert. In the milling cutter, the cutting inserts are alternately mounted in pockets formed on a side surface of the milling cutter so that the concavo-convex portions of the active main cutting edges of the cutting inserts which are adjacent to each other are staggered with respect to each other.

### RELATED APPLICATIONS

This is a continuation-in-part of international application no. PCT/KR2009/004132, filed 24-Jul.-2009, which published as WO 2010/021463A2, and claims priority to KR 10-2008-0081322, filed 20-Aug.-2008. The contents of the aforementioned applications are incorporated by reference in their entirety.

### TECHNICAL FIELD

The present invention relates to a cutting insert having improved main cutting edges and a milling cutter provided with the same.

Particularly, the present invention relates to a cutting insert and a milling cutter provided with the same, wherein the main cutting edges of the cutting insert have a concavo-convex shape and are asymmetrically configured. A plurality of cutting inserts are mounted in different orientations so that the concavo-convex patterns of the main cutting edges are staggered with respect to each other.

### BACKGROUND ART

Generally, a plurality of cutting edges are assembled on a surface of a milling cutter to machine a workpiece. Therefore, the effectiveness of the milling cutter depends on the cutting depth and the shape of a cutting insert.

Recently, the development of new machining tools has enabled the milling process to realize high speed machining and high speed transfer machining. In addition to the introduction of new tools, in order to improve productivity the cut depth has been increased, so a method for removing chips has been widely used.

A conventional cutting insert 1 comprises a total of six surfaces having oppositely facing front and back surfaces 2 and 3 spaced apart from one another t in a thicknesswise direction of the insert, and upper, lower, left and right surfaces 4, 5, 6 and 7 configured along the perimeters of the cutting insert and connecting the front and back surfaces 2 and 3. In addition, the cutting insert 1 is provided with main cutting edges 8 positioned along the four sides of both the front and back surfaces 2 and 3 of the cutting insert, and subsidiary cutting edges 9 which are located along the two sides of both the upper and lower surfaces 4 and 5 thereof.

If the entire length of a main cutting edge is used for cutting in order to increase the cutting area when a workpiece is cut using such a cutting insert 1, there is a problem in that the cutting resistance is increased thereby reducing the life of the cutting insert. Further, there is a problem in that since an increase in vibration and noise is proportional to an increase in the cutting resistance, the degree of machining for a workpiece may be reduced.

### SUMMARY OF THE INVENTION

Accordingly, the present invention has been conceived in order to solve the aforementioned problems in the prior art. An object of the present invention is to provide a cutting insert, in which the main cutting edges have concavo-convex portions and are asymmetrically configured, so that the cutting resistance can be reduced.

In addition, another object of the present invention is to provide a milling cutter, wherein the cutting inserts of the present invention can be mounted so that the concavo-convex patterns of the main cutting edges are staggered with respect to each other, thereby being economical and making it easy to mount the cutting inserts.

According to a first aspect of the present invention, a cutting insert is provided, which has a hexahedral shape with oppositely facing front and back surfaces spaced apart from one another in a thicknesswise direction of the insert, and upper, lower, left and right surfaces along the perimeter of the front and back surfaces. The cutting insert is formed with a coupling hole passing through the front and back surfaces, and includes main cutting edges along both lengthwise edges of the front surface. The main cutting edges of the front surface have concavo-convex shapes, and the concavo-convex shapes are staggered and asymmetrical with each other.

According to a second aspect of the present invention, a milling cutter is provided wherein a plurality of the cutting inserts of the present invention are mounted to pockets formed on a side surface of a main body of the milling cutter so that the concavo-convex shapes of the main cutting edges are staggered with each other in upward and downward directions.

### BRIEF DESCRIPTION OF DRAWINGS

FIG. 1 is a perspective view showing an example of a conventional cutting insert.

FIG. 2 is a perspective view of a cutting insert according to the present invention.

FIG. 3 is a front or rear view of the cutting insert according to the present invention.

FIG. 4 is a view showing a milling cutter assembled with cutting inserts according to the present invention.

FIG. 5 is a view showing cutting inserts according to the present invention before being assembled in the pocket of the milling cutter according to the present invention.

FIG. 6 is a view showing the cutting operation being performed after the cutting inserts according to the present invention are mounted so as to be staggered with each other.

FIG. 7 is a view showing the cutting insert according to the present invention normally seated in a pocket.

FIG. 8 is a view showing the cutting insert according to the present invention abnormally seated in the pocket.

FIG. 9 shows a cutting insert according to another embodiment of the present invention.

FIG. 10 shows a cutting insert according to a further embodiment of the present invention.

FIG. 11 shows a cutting insert according to a still further embodiment of the present invention.

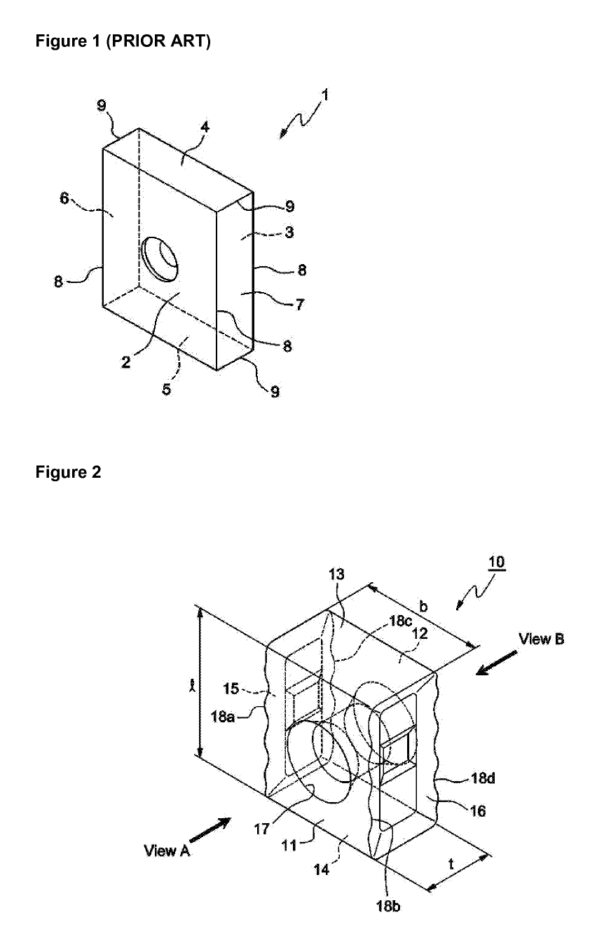

### DETAILED DESCRIPTION

A cutting insert and a milling cutter according to the present invention will be described in detail with reference to the accompanying drawings and following embodiments.

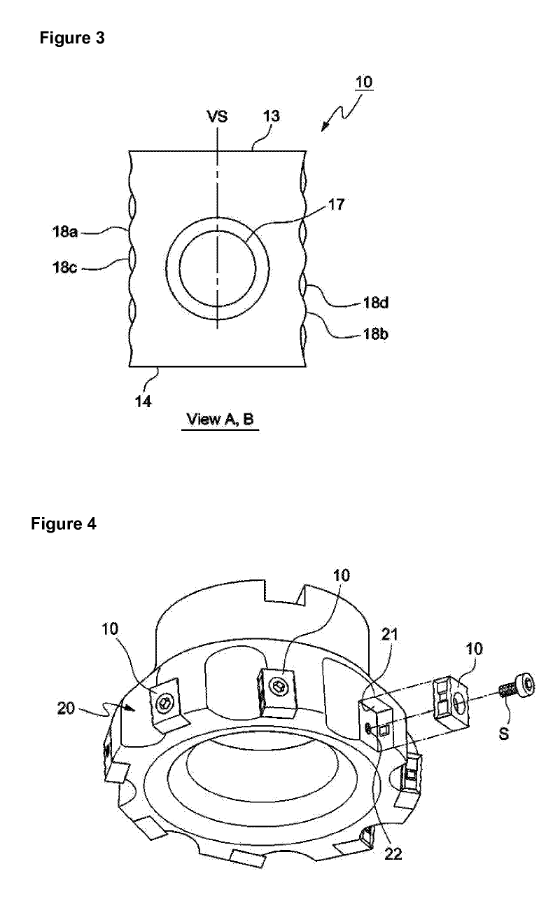

FIG. 2 is a perspective view of a cutting insert according to the present invention, and FIG. 3 is a front or rear view of FIG. 2.

As shown in the figures, a cutting insert 10 according to the present invention has a rectangular hexahedral shape with oppositely facing front and back surfaces 11 and 12 spaced apart from one another in a thicknesswise direction of the insert, and upper, lower, left and right surfaces 13, 14, 15 and 16 along the perimeters of the front and back surfaces 11 and 12.

In addition, the cutting insert 10 according to the present invention is formed with a coupling hole 17 in the front and back surfaces 11 and 12, through which a coupling screw S passes.

Further, the cutting insert 10 according to the present invention has two or four main cutting edges for cutting a surface of a workpiece, and two or four subsidiary cutting edges for cutting an orthogonal surface of the workpiece adjacent to the surface to be cut.

The main cutting edges 18a, 18b, 18c and 18d may comprise the first and second main cutting edges 18a and 18b which are located along the two lengthwise edges of the front surface 11 of the cutting insert 10, and may further comprise the third and fourth main cutting edges 18c and 18d which are located along the two lengthwise edges of the back surface 12.

According to the present invention, the main cutting edges 18a to 18d have wave-shaped concavo-convex portions. As shown in FIGS. 2 and 3, it is preferable that each of the main cutting edges 18a, 18b, 18c and 18d have a wave shape as viewed in a thicknesswise direction (direction viewing the front or back surfaces 11, 12) of the cutting insert, and have a linear shape as viewed in a widthwise direction (direction viewing the left or right surfaces 15, 16) of the insert body.

Further, it is preferable that the wave shape be repeated and formed periodically with the same size and shape. However, the wave shape may not be periodically repeated if necessary, and a wave having a combination of various lines and curves may be allowed. The aforementioned wave shape may cause the length of the cutting edge to be longer than that of a cutting edge having a linear shape.

According to a preferred embodiment, the concavo-convex shapes of the first and second main cutting edges 18a and 18b are configured so as to be staggered with respect to each other and to be asymmetrical with each other. The third and fourth main cutting edges 18c and 18d are configured so as to be rotationally symmetrical with the first and second main cutting edges 18a and 18b by 180 degrees with respect to a longitudinal central axis VS of the insert body. That is, the front and back surfaces 11 and 12 are shaped so as to be interchangeable with respect to the longitudinal central axis VS.

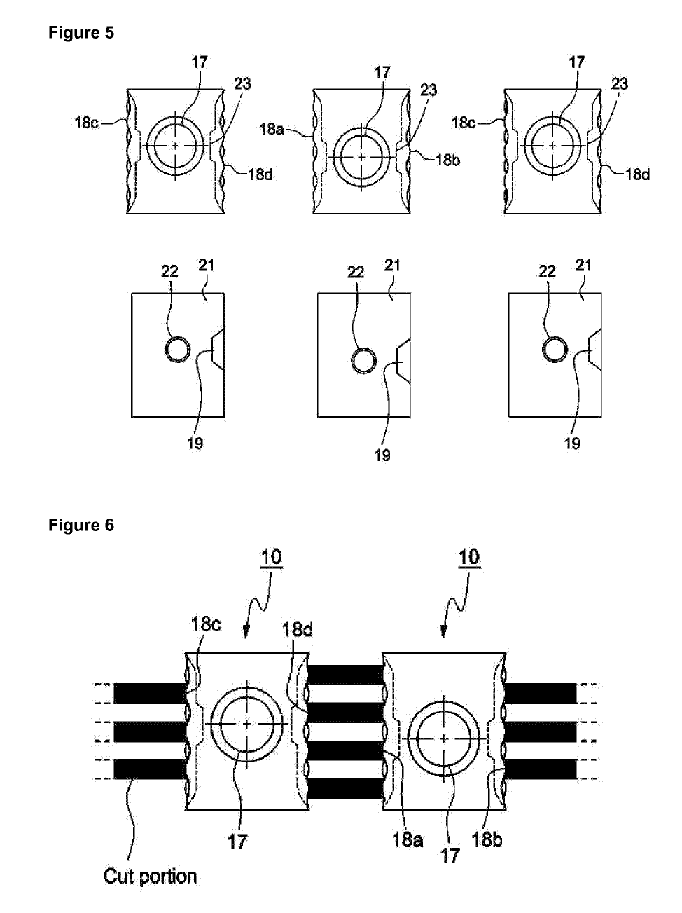

FIG. 4 shows cutting inserts 10 according to the present invention mounted to a cutter main body 20; and FIG. 5 is a front view showing the cutting inserts 10 before they are mounted to the cutter main body 20.

As shown in the figures, if a first cutting insert 10 according to the present invention is mounted to the cutter main body 20 so that the first main cutting edge 18a of the cutting insert is configured to be the active main cutting edge, an adjacent second cutting insert is mounted in the cutter main body so as to be reversed by 180 degrees with respect to the central axis of the front and back surfaces of the first cutting insert 10 so that the second main cutting edge 18b of the adjacent second cutting insert is configured as the active main cutting edge. Accordingly, the cutting inserts may be mounted so that the concavo-convex portions of the active main cutting edges of two adjacent cutting inserts are alternately staggered with each other.

FIG. 6 is a view showing the cutting operation being performed after the cutting inserts according to the present invention are mounted so that the concavo-convex portions of the active main cutting edges of the cutting inserts are staggered with respect to each other.

As shown in FIG. 6, according to the aforementioned mounting method, a workpiece is mostly cut by ridge portions of the main cutting edge in one cutting insert and relatively insignificantly cut by valley portions thereof. However, a trailing cutting insert is mounted so that the ridge and valley portions thereof are staggered with those of the leading cutting insert.

Accordingly, the portions insufficiently cut by the leading cutting insert may be complementarily cut by the ridge portion of the trailing cutting insert, so that precise and uniform cutting can be realized.

According to the present invention, as shown in FIG. 5, the coupling hole 17 of the cutting insert 10 is configured so as to be eccentric from the center of the insert body in a lengthwise direction, so that it is possible to prevent a cutting insert mounting error when the active main cutting edges of the respective cutting inserts are mounted so as to be alternately staggered with respect to each other as described above.

That is, if the coupling holes 17 of the respective cutting inserts 10 are configured so as to be eccentric in the lengthwise direction, the position of the coupling holes 17 of the respective cutting inserts 10 are alternately changed upwards and downwards when the cutting inserts 10 are alternately normally and reversibly mounted with respect to each other.

Accordingly, if a screw connection hole 22 formed in each pocket 21 of the cutter main body 20 according to the present invention is designed so as to be positioned corresponding to the coupling hole 17, a mounting error can be prevented since the cutting insert 10 is precisely mounted in the pocket 21 only when the position of the coupling hole 17 is identical to that of the screw connection hole 22.

However, since the mounting error cannot be completely prevented only by the arrangement of the coupling hole 17 and the screw connection hole 22, it is preferable that a configuration for preventing a mounting error, as a means of settling the problem, is provided which comprises a convex portion 19 and a concave portion 23 respectively provided at the cutter main body 20 and the cutting insert 10.

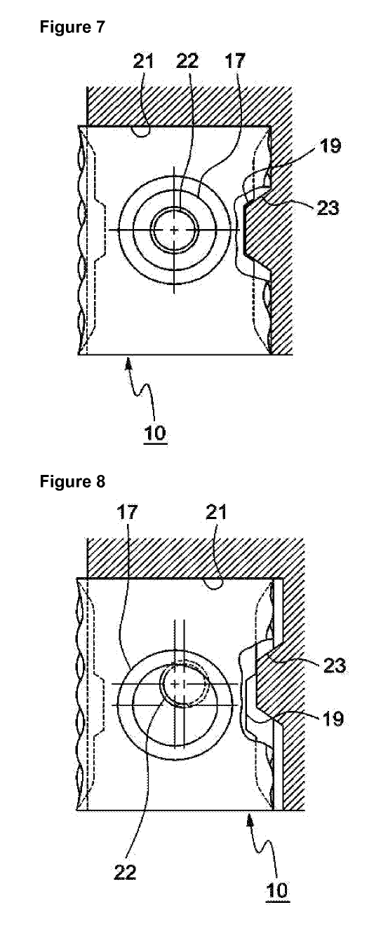

Such a configuration for preventing a mounting error will be appreciated with reference to FIGS. 7 and 8.

If the first main cutting edge 18a of one cutting insert, which is mounted in the normal direction, is configured as the active main cutting edge, the second main cutting edge 18b of another cutting insert, which is mounted in the reverse direction, should be configured as the active main cutting edge. However, it is difficult to completely prevent the error that a cutting insert is mounted in order for the third main cutting edge 18c to function as the active main cutting edge only by means of the eccentric configuration of the coupling holes 17 and the screw connection holes 22 as described above.

Accordingly, the concave portion 23 is provided eccentrically in the lengthwise direction on the left or right surface 15 or 16 of the cutting insert 10 according to the present invention, while the convex portion 19 is provided on a mounting surface of the pocket 21 opposite thereto. Accordingly, when the cutting insert is normally mounted, the convex portion 19 and the concave portion 23 are aligned with each other as shown in FIG. 7, whereas when the cutting insert is abnormally mounted, the convex portion 19 and the concave portion 23 are unaligned as shown in FIG. 8 and thus cannot be smoothly mounted to each other, so that the mounting error can be completely prevented. As seen in FIGS. 7 and 8 (esp. the left edges of the cutting insert) and also in FIG. 3, due to the wave shaped main cutting edges, the concave portion 23 are hidden and cannot be seen in a front or rear view of the cutting insert 10.

FIGS. 9, 10 and 11 respectively show cutting inserts according to other embodiments of the present invention.

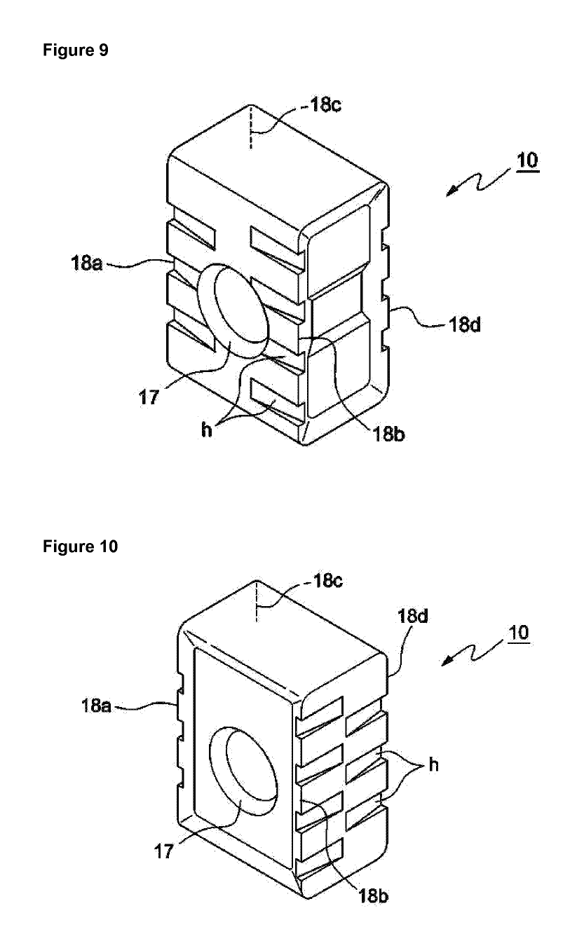

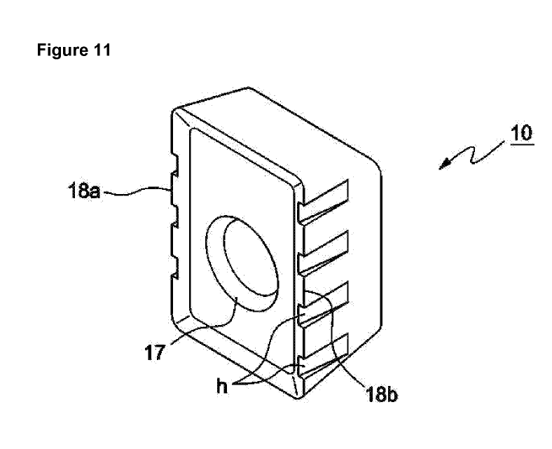

According to the figures, the main cutting edges of the cutting insert 10 according to the present invention may be configured so as to have a square-wave type concavo-convex shape, which is formed in the widthwise direction of the insert body, instead of the wave shape. Further, as shown in FIGS. 9 and 10, the main cutting edges may be formed on both the front and back surfaces 11 and 12. Alternatively, as shown in FIG. 11, the main cutting edges may be formed on any one of the front and back surfaces 11 and 12.

In a first embodiment in which the main cutting edges 18a to 18d are configured so as to have a square-wave type concavo-convex shape, as shown in FIG. 9, asymmetrical grooves h are formed on the front and back surfaces 11 and 12 of the insert body on both sides of the coupling hole 17. Here, the grooves h gradually increase in depth from the coupling hole 17 towards the opposite lengthwise edges associated with each of the front and back surfaces 11 and 12, while extending in a widthwise direction of the cutting insert, (i.e., the grooves gradually decrease in depth from each one of the lengthwise edges, while extending in a widthwise direction of the cutting insert towards the opposite lengthwise edge associated with the same front or back surface), so that the cutting edges having concavo-convex shapes can be formed along the lengthwise edges of the front and back surface 11 and 12.

In a second embodiment in which the main cutting edges 18a to 18d are configured so as to have a square-wave type concavo-convex shape, as shown in FIG. 10, asymmetrical grooves h are formed on the left and right surfaces 15 and 16 of the insert body towards both sides with respect to the longitudinal central axis of the left and right surfaces. Here, the grooves gradually increase in depth from the longitudinal central axis towards the opposite lengthwise edges associated with each of the left and right surfaces 15, 16, while extending in a thicknesswise direction of the cutting insert, (i.e., the grooves gradually decrease in depth from each lengthwise edge, while extending in a thicknesswise direction of the cutting insert toward the opposite lengthwise edge associated with the same left or right surface), so that the cutting edges having concavo-convex shapes can be formed along the lengthwise edges of the left and right surfaces.

In a third embodiment in which the main cutting edges 18a and 18b are configured so as to have a square-wave type concavo-convex shape, as shown in FIG. 11, the left and right surfaces 15 and 16 of the insert body are tapered in one direction, and grooves h are formed towards one side with respect to the longitudinal central axis of the left and right surfaces. Here, the grooves gradually increase in depth from the longitudinal central axis towards the lengthwise edges, so that the cutting edges having concavo-convex shapes can be formed along the side edges of the left and right surfaces, but only proximate the front surface. Thus, the cutting insert seen in FIG. 11 is “single-sided”, having upper and lower surfaces that are different from one another and not interchangeable, the lower surface always serves as a seating surface.

If the grooves and the projections in the square-wave type concavo-convex portions as described above are smoothly curved, they can be converted into the wave-shaped concavo-convex portions.

According to the present invention so described, main cutting edges are configured to have concavo-convex shapes and be asymmetrical with each other, whereby the length of each main cutting edge may be magnified. Further, the cutting inserts are mounted in different mounting directions so that the concavo-convex patterns of the main cutting edges can be staggered with respect to each other, whereby it is possible to realize the functional effects which would be obtained by mounting two different types of cutting inserts.

Further, a means for preventing a mounting error is provided, so that the mounting error of the cutting inserts can be prevented when the cutting inserts are mounted in order for the main cutting edges thereof to be staggered with each other, thereby providing a user with convenience.

The aforementioned embodiments of the present invention are disclosed for illustrative purposes only. It will be apparent to those skilled in the art that various modifications, changes and additions thereto may be made within the spirit and scope of the invention. These modifications, changes and additions will be included in the scope defined by the appended claims.

What is claimed is:

1. A cutting insert comprising:
a hexahedral shape with oppositely facing front and back surfaces spaced apart from one another in a thicknesswise direction of the insert, and upper, lower, left and right surfaces along the perimeters of the front and back surfaces;
a coupling hole passing through the front and back surfaces; and
main cutting edges along both lengthwise edges of the front surface;
wherein the main cutting edges along both the lengthwise edges of the front surface have concavo-convex shapes, and the two concavo-convex shapes are staggered and asymmetrical with respect to each other.

2. The cutting insert as claimed in claim 1, further comprising:
main cutting edges positioned along both lengthwise edges of the back surface;
wherein the main cutting edges of the back surface are rotationally symmetrical with those of the front surface by 180 degrees with respect to a longitudinal central axis of the cutting insert.

3. The cutting insert as claimed in claim 1, wherein the concavo-convex shape is a wave or square-wave type concavo-convex shape.

4. The cutting insert as claimed in claim 3, wherein the concavo-convex shape is formed in a widthwise direction or a thicknesswise direction of the cutting insert.

5. The cutting insert as claimed in claim 1, wherein the coupling hole is positioned so as to be eccentric in a lengthwise direction from the center of the cutting insert.

6. The cutting insert as claimed in claim 1, wherein concave portions for preventing a mounting error of the cutting insert are formed on the left and right surfaces of the cutting insert, the concave portions being eccentric in a lengthwise direction from a center of the cutting insert.

7. The cutting insert as claimed in claim 6, wherein the concave portions are hidden in a front or rear view of the cutting insert.

8. The cutting insert as claimed in claim 1, further comprising:
asymmetrical grooves formed on the front surface of the insert body on both sides of the coupling hole;
wherein:
the coupling hole is positioned so as to be eccentric in a lengthwise direction from the center of the cutting insert; and
the grooves on the front surface gradually decrease in depth from each one of the lengthwise edges, while extending in a widthwise direction of the cutting insert towards the opposite lengthwise edge associated with the front surface.

9. The cutting insert as claimed in claim 8, further comprising:
asymmetrical grooves formed on the back surface of the insert body on both sides of the coupling hole; and
main cutting edges along both lengthwise edges of the back surface;
wherein:
the grooves on the back surface gradually decrease in depth from each one of the lengthwise edges, while extending in a widthwise direction of the cutting insert towards the opposite lengthwise edge associated with the back surface.

10. The cutting insert as claimed in claim 8, wherein concave portions for preventing a mounting error of the cutting insert are formed on the left and right surfaces of the cutting insert, the concave portions being eccentric in a lengthwise direction from a center of the cutting insert.

11. The cutting insert as claimed in claim 10, wherein the concave portions are hidden in a front or rear view of the cutting insert.

12. The cutting insert as claimed in claim 1, further comprising:
asymmetrical grooves formed on the left and right side surfaces of the insert body; wherein:
the coupling hole is positioned so as to be eccentric in a lengthwise direction from the center of the cutting insert; and
the grooves gradually decrease in depth from each lengthwise edge, while extending in a thicknesswise direction of the cutting insert toward the opposite lengthwise edge associated with the same left or right surface.

13. The cutting insert as claimed in claim 1, further comprising:
asymmetrical grooves formed on the left and right side surfaces of the insert body; wherein:
the coupling hole is positioned so as to be eccentric in a lengthwise direction from the center of the cutting insert;
the first set of grooves gradually decrease in depth from the lengthwise edges associated with the front surface, while extending in a thicknesswise direction of the cutting insert toward corresponding lengthwise edges associated with the back surface; and
the cutting insert is single-sided and the front and back surfaces are dissimilar.

14. A milling cutter comprising:
a cutter main body having a rotational axis and a side surface provided with a plurality of pockets; and
a cutting insert seated in each of said plurality of pockets; wherein
each cutting insert is in accordance with the cutting insert of claim 1; and
the cutting inserts are arranged in the pockets so that the concavo-convex shapes of the main cutting edges are staggered with respect to each other along upward and downward directions along the rotational axis.

15. The milling cutter as claimed in claim 14, wherein:
each pocket has a screw connection hole to which a corresponding insert is fixed; and
the screw connection holes are arranged so as to be staggered with respect to each other along upward and downward directions along the rotational axis.

16. The milling cutter as claimed in claim 14, wherein:
each of the left surface and the right surface of each cutting insert is formed with a concave portion for preventing a mounting error of the cutting insert, the concave portion being eccentric in a lengthwise direction from a center of the cutting insert; and
each pocket comprises a convex portion corresponding to the concave portions on the left and right surfaces, the convex portions being staggered with respect to each other along upward and downward directions along the rotational axis.
